(19) United States
(12) Patent Application Publication
(10) Pub. No.: US 2005/0282501 A1
(43) Pub. Date: Dec. 22, 2005

(54) Method of determining interference and terminal device

(75) Inventor: Satoshi Oura, Tokyo (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/145,616

(22) Filed: Jun. 6, 2005

(30) Foreign Application Priority Data
Jun. 7, 2004 (JP) 2004-168708

(51) Int. Cl. H04B 15/00

(52) U.S. Cl. 455/67.13; 455/63.1

(57) ABSTRACT

A station (STA) that performs communication with an access point includes an FCS error detecting section that detects an error of all packet data of received data on hardware and a CRC error detecting section that extracts data addressed to the STA from received data through a MAC filter to detect an error of extracted data again on software. An SME compares the error values detected through the two error detections to each other, detects, based on the comparison result, whether or not interference of an interfering wave exists, and causes a utility to display a status of interference. In addition, the SME instructs a hardware section to change a channel used for communication.

### BACKGROUND OF THE INVENTION

1. Field of the Invention

The present invention relates to a method of determining interference of a terminal device (station which, hereinafter, is simply referred to as STA) in a wireless LAN system and a terminal device. More particularly, the present invention relates to a method of determining interference to the STA when communication is performed between an access point (AP) in the wireless LAN system and the STA using the AP.

2. Description of the Related Art

In recent years, an access point (AP) of a wireless LAN system is provided in a space for public use or in a store, such that a user can receive various services using the AP.

Generally, a terminal device, which has access the AP of the wireless LAN system, is a portable information processing device, such as a PC, a PDA, or the like. When communication is performed between the AP and the STA, electric waves transmitted from other APs and other terminal devices interfere with the terminal device as interfering waves. As a result, a communication trouble occurs in the terminal device.

FIG. 2 is a block diagram showing the configuration of a general wireless LAN system. The interference caused by the interfering waves will be described with reference to FIG. 2. In FIG. 2, reference numerals 21 and 22 denote access points (APs) and reference numerals 23 and 24 denote terminal devices (STA).

As shown in FIG. 2, the wireless LAN system includes the plurality of APs 21 and 22 for performing information providing services and the STAs 23 and 24 which communicate with other STAs via the APs and receive various information providing services. In FIG. 2, it is assumed that the STA 23 and the AP 21 communicate with each other through a communication path (a). In this state, the STA 24 adjacent to the STA 23 starts communication with the AP 21 through a path (b) or starts communication with the AP 22. In this case, the STA 23 receives interfering waves from the AP 22 through a path (c) or from the STA 24 through a path (d) during the communication with the AP 21. As a result, the interfering waves interfere with electric waves which should be received by the STA 23 from the AP 21, which causes interference.

When the interference described above occurs, in the STA 23, a throughput for a data transfer through the communication is lowered. However, a user using the STA 23 cannot recognize what causes the throughput to be lowered. Specifically, the user can recognize the true that an effective throughput decreases. However, it is difficult for the user to confirm whether or not the throughput is lowered due to the interference of the interfering waves. In addition, in the related art, a technique for detecting the lowering of the throughput due to the interfering waves has not been suggested.

Further, there is known a technique disclosed in Japanese Unexamined Patent Application Publication No. 10-164073 which is an example of the related art on the wireless LAN system.

As described above, generally, the user using the wireless LAN can recognize the true that the effective throughput decreases. However, it is difficult for the user to confirm whether or not the throughput is lowered due to the interference of the interfering waves.

### SUMMARY OF THE INVENTION

Accordingly, the invention has been made in consideration of the above problems, and it is an object of the invention to provide a method of determining interference of a wireless LAN system which can determine a status of interference to a terminal device when communication is performed between an access point (AP) and a station (STA) using the AP in the wireless LAN system, and a terminal device.

According to a first aspect of the invention, there is provided a method of determining interference of a terminal device that performs communication with an access point. The method includes a first error detecting step of detecting an error of received data on hardware, a second error detecting step of processing received data by an MAC filter to detect an error of data addressed to the terminal device again on software, and an interference detecting step of comparing the error values detected in the first and second error detecting steps to each other to determine, based on the comparison result, whether or not interference of an interfering wave exists.

Further, it is preferable that the method of determining interference further includes an electric wave status grasping step of detecting the intensity of a received signal to grasp a status of an electric wave and an electric wave status display step of displaying the ratio of the error values detected in the first and second error detecting steps and the status of the electric wave grasped in the electric wave status grasping step.

Further, it is preferable that the method of determining interference further includes, when it is determined in the interference detecting step that the interference of the interfering wave exists, a channel changing step of changing a channel.

According to a second aspect of the invention, there is provided a terminal device for performing communication with an access point. The terminal device includes a first error detecting unit that detects an error of received data on hardware, a second error detecting unit that processes received data by an MAC filter to detect an error of data addressed to the terminal device again on software, and an interference detecting unit that compares the error values detected by the first and second error detecting units to each other to determine, based on the comparison result, whether or not interference of an interfering wave exists.

Further, it is preferable that the terminal device further includes an electric wave status grasping unit that detects the intensity of a received signal to grasp a status of the electric wave and an electric wave status display unit that displays the ratio of the error values detected by the first and second error detecting units and the status of the electric wave grasped by the electric wave status grasping unit.

Furthermore, it is preferable that the terminal device further includes a channel changing unit that, when it is determined by the interference detecting unit that the interference of the interfering wave exists, changes a channel.

### BRIEF DESCRIPTION OF THE DRAWINGS

FIG. 1 is a block diagram showing a configuration of main parts of a terminal device (STA) according to an embodiment of the invention; and

FIG. 2 is a block diagram showing a configuration of a general wireless LAN system.

### DESCRIPTION OF THE PREFERRED EMBODIMENT

Hereinafter, an embodiment of a method of determining interference of a terminal device in a wireless LAN system, and a terminal device will be described in detail with reference to the drawings.

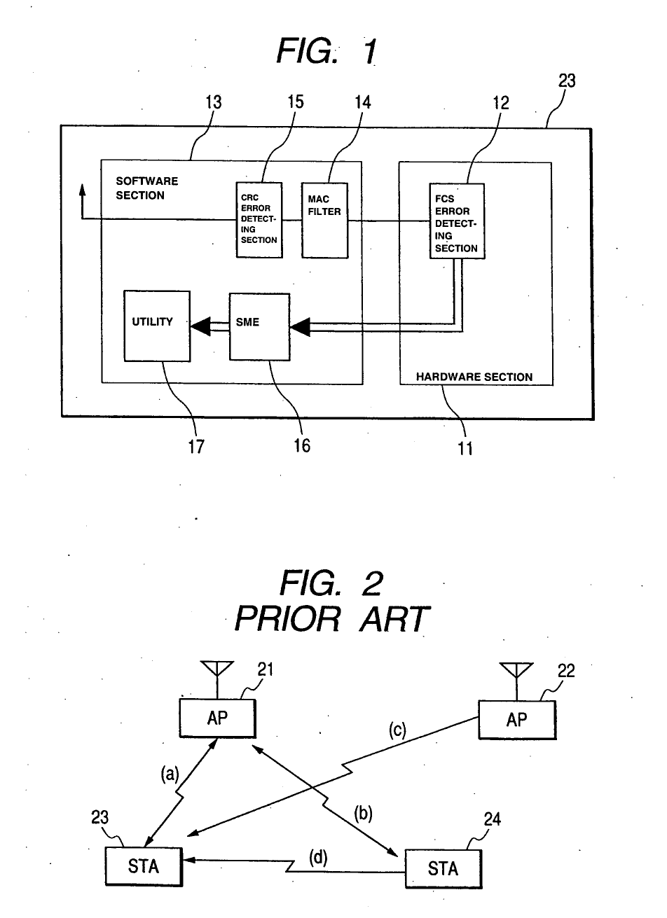

FIG. 1 is a block diagram showing the configuration of main parts of a terminal device (STA) according to an embodiment of the invention. In FIG. 1, reference numeral 11 denotes a hardware section, reference numeral 12 denotes an FCS error detecting section, reference numeral 13 denotes a software section, reference numeral 14 denotes an MAC filter, reference numeral 15 denotes a CRC error detecting section, reference numeral 16 denotes an SME (station management entity), and reference numeral 17 denotes a utility.

As shown in FIG. 1, the configuration of the STA 23 corresponds to a portion that performs the communication of the wireless LAN system incorporated into a PDA, a PC, or the like. The STA 23 includes the hardware section 11 having a high frequency processing section (not shown) and a baseband processing section, and a software section 17 that transmits data from a host device, such as the PDA, the PC, or the like, to the hardware section 11 or transmits data received and decoded by the hardware section 11 to the above-mentioned host device.

In addition, in the hardware section 11, the FCS error detecting section 12 that performs an error detection on all received data according to a frame check sequence is provided. In addition, the software section 13 has the MAC filter 14 that extracts only data addressed to the STA, the CRC error detecting section 15 that performs an error detection on data addressed to the STA through a CRC check and delivers data addressed to the STA to the host device, such as the PDA, PC, or the like, the SME 16 that monitors and controls all main parts of the STA shown in FIG. 1 and determines a status of interference according to the invention, and the utility 17 that performs a process, such as an output of information to a user.

In the STA having the above-mentioned configuration, the FCS error detecting section 12 performs the error detection, according to the frame check sequence, on all packet data decoded from electric waves received by the STA and transmits data after the error detection to the MAC filter 14 of the software section 13 and transmits information on the error, such as an error rate, to the SME 16.

The MAC filter 14 extracts data addressed to the STA from received data and delivers extracted data to the CRC error detecting section 15. The CRC error detecting section 15 performs the error detection and the correction on data addressed to the STA and delivers data to the host device, such as the PDA, the PC, or the like, and transmits information on the error, such as an error rate, to the SME 16. The SME 16 determines the status of interference based on the information on the error from the FCS error detecting section 12 and the information on the error from the CRC error detecting section 15 and delivers the determination result to the utility 17. The utility 17 controls a display device of the host device to display the received status of interference.

Here, when the error rate of the packet data detected by the FCS error detecting section 12 is set to A and the error rate of the packet data detected by the CRC error detecting section 15 is set to B, if the interference of an interfering wave does not exist, the condition A≅B is satisfied. When the interference of the interfering wave exists, the condition A>>B is satisfied.

The SME 16 calculates the ratio A/B of data error rates transmitted from the two error detecting sections using the characteristics between two kinds of data error rates described above and determines whether or not the interference of the interfering wave exists. For the determination, whether or not the ratio A/B of the error rates exceeds a predetermined value can be detected. In addition, the SME 16 can determine the status of interference of the interfering wave by adding the intensity of a received signal (RSSI) detected by and transmitted from the hardware section 11.

As regards the status of interference, the utility 17 may display only presence/absence of the interference or may display the ratio A/B of interference rates by changing a length of a bar according to the ratio of the error rates. Further, the RSSI can be simultaneously displayed.

Further, when it is detected that the ratio A/B of the error rates exceeds the predetermined value, the SME 16 instructs the hardware section 11 to change a channel used for the communication of the STA.

According to the embodiment of the invention described above, when the communication is performed between the AP and the STA using the AP in the wireless LAN system, the interference to the terminal device can be determined and a user can be notified of the status of interference. In addition, when the interference becomes large, the used channel can be automatically changed.

1. A method of determining interference of a terminal device that performs communication with an access point, the method comprising:
a first error detecting step of detecting an error of received data on hardware;
a second error detecting step of processing the received data through a MAC filter to detect an error of data addressed to the terminal device again on software; and
an interference detecting step of comparing the error values detected in the first and second error detecting steps to each other to determine, based on a comparison result, whether or not interference of an interfering wave exits.

2. The method of determining interference according to claim 1, further comprising:
an electric wave status grasping step of detecting an intensity of a received signal to grasp a status of an electric wave; and
an electric wave status determining step of displaying a ratio of the error values detected in the first and second error detecting steps and the status of the electric wave grasped by the electric wave status grasping step.

3. The method of determining interference according to claim 1, further comprising;
a channel changing step of, when it is determined in the interference detecting step that the interference of the interfering wave exists, changing a channel.

4. A terminal device that performs a communication with an access point, comprising:
a first error detecting unit that detects an error of received data on hardware;
a second error detecting unit that processes the received data through a MAC filter to detect an error of data addressed to the terminal device again on software; and
an interference detecting unit that compares a ratio of the error values detected by the first and second error detecting units to each other to determine, based on a comparison result, whether or not interference of an interfering wave exists.

5. The terminal device according to claim 4, further comprising:
an electric wave status grasping unit that detects an intensity of a received signal to grasp a status of an electric wave; and
an electric wave status display unit that displays the ratio of the error values detected by the first and second error detecting units and the status of the electric wave grasped by the electric wave status grasping unit.

6. The terminal device according to claim 4, further comprising;
a channel changing unit that, when it is determined by the interference detecting unit that the interference of the interfering wave exists, changes a channel.
